(19) United States
(12) Patent Application Publication
(10) Pub. No.: US 2010/0245023 A1
(43) Pub. Date: Sep. 30, 2010

(54) SAFETY FUSIBLE CONNECTOR

(76) Inventor: STEVEN MASSINGILL, Hamilton, TX (US)

Correspondence Address: Thien Tran/ Access Patent Group, LLC, 7706 Tanner Robert Court, Springfield, VA, 22153, US

(21) Appl. No.: 12/748,371

(22) Filed: Mar. 26, 2010

Related U.S. Application Data
(60) Provisional application No. 61/163,494, filed on Mar. 26, 2009.

(51) Int. Cl. H01H 71/10

(52) U.S. Cl. 337/171; 337/168

(57) ABSTRACT

A safety fusible connector extends between a main feed and a tap of a power line. The connector comprises an insulated tube. A protective sleeve is mounted within an upper portion of the insulated tube. A fuse has an upper contact and a lower elongated fuse line, wherein the fuse is placed within the protective sleeve. A first component is attachable to a top end of the insulated tube for electrically clamping the upper contact of the fuse to the main feed. A second component is attachable to a bottom end of the insulated tube for electrically connecting the fuse line of the fuse to the tap. If a current fault occurs in the tap, the fuse will blow and cause the second component to disconnect the fuse line, so that the main feed can still have power.

### CROSS-REFERENCE TO RELATED APPLICATION

This application claims the benefit of Provisional Patent Application No. 61/163,494, filed on Mar. 26, 2009, In the United States Patent & Trademark Office, the disclosure of which is incorporated herein by reference.

### BACKGROUND OF THE INVENTION

1. Field of the Invention

The present invention relates to a power line safety mechanism, and more particularly, a safety fusible connector.

Currently, utility companies use solid jumpers and mechanicals when working on power lines. If there is an accident or fault on the tap the lineman is working on, there is a chance that a flash fire could occur. The fire can knock out electricity on the main feeder all the way to the substation. It can also put the lineman in extreme danger. The shock or fire can cause burns to the worker, knock him off balance and cause a fall, and may even result in death. Presently, there are no precautions in place in case of an accident.

The safety fusible connector is a safety mechanism used when working on energized power lines. The connector forms a fusible link between a main feed and a tap, which will cause the fuse to blow in the event of an accident or current fault. Only the tap will lose power, leaving the main feed uninterrupted. The connector eliminates instances where power is lost all the way to the substation and also decreases the chances of a flash fire or injury to the lineman. All utility companies would find the connector useful in ensuring that linemen are safe, while also maintaining a satisfactory level of service by keeping the power flow continuous.

2. Description of the Prior Art

Numerous innovations for fuse cutouts have been provided in the prior art that will be described. Even though these innovations may be suitable for the specific individual purposes to which they address, however, they differ from the present invention.

A FIRST EXAMPLE, U.S. Pat. No. 1,959,595, Issued on May 22, 1934, to Miller teaches a fuse switch including a tube, head and foot members on the upper and lower ends of the tube, a fusible conductor element housed within the tube and having its ends connected to the head and foot members, an arm on one of the members, and spring means tensioned over the arm and engaging the fusible conductor element for effecting withdrawal of the fuse element from the tube upon fusing thereof.

A SECOND EXAMPLE, U.S. Pat. No. 2,680,171, Issued on Jun. 1, 1954, to Curtis et al. teaches an electric fuse comprising a fuse tube, a fusible element secured within the tube and having a portion thereof extending out of one end of the tube, a conducting element movably supported by the tube and having a normal position with respect thereto, an ejector element movably supported by the conducting element and having a normal position with respect thereto from which the ejector is movable in only one direction, the portion of the fusible element being normally interrelated with the ejector element so as to hold the ejector element in its normal position relative to the conducting element, and manual means for moving the conducting element out of its normal position without moving the ejector element relative to the conducting element thereby physically to break the fusible element.

A THIRD EXAMPLE, U.S. Pat. No. 2,986,619, Issued on May 30, 1961, to McCloud teaches a fuse construction comprising a C-shaped main body portion formed of resilient fiber glass having upper and lower stationary contacts and having a supporting member intermediate the upper and lower ends of the body portion and spaced substantially the maximum distance from the upper and the lower stationary contacts to minimize flashovers, and an expulsion fuse tube having upper and lower movable contacts normally in engagement with the upper and lower stationary contacts.

A FOURTH EXAMPLE, U.S. Pat. No. 3,094,597, Issued on Jun. 18, 1963, to Barta teaches a circuit disconnecting device for operation by an auxiliary circuit interrupter having a pair of separable contacting conducting parts, the device comprising, in combination, upper and lower line terminal members and means mounting them in insulated spaced relation, rigid elongated conducting means having upper and lower electrically interconnected terminals, means mounting the lower terminal on the lower line terminal member to rotate about a pivot axis, contact means on the upper line terminal member, the upper terminal including a conducting member in contact engagement with the contact means and a pull ring extending upwardly from the conducting member in a plane at right angles to the pivot axis to be engaged by one of the separable contacting parts of the auxiliary circuit interrupter, and a hook member having a shank secured to the upper line terminal member and a hook portion adjacent and turned away from the pull ring for receiving the other separable contacting conducting part of the auxiliary circuit interrupter.

A FIFTH EXAMPLE, U.S. Pat. No. 3,344,251, Issued on Aug. 26, 1964, to Misare teaches a fuse construction comprising a fuse tube having a terminal structure at one end; a fuse link capable of interruptions upon abnormal amperage faults and extending through the fuse tube and provided with a disc shaped head at the one end of the tube; and a cap normally threadingly engaging the terminal to retain the head and to close the one end of the fuse tube; the cap including an internally threaded sleeve and an externally threaded thin disc closing the sleeve and threadingly received in the sleeve and rupturable along its threaded edges when a predetermined pressure is developed in the fuse tube upon explosive interruption of the fuse link in response to high amperage faults.

A SIXTH EXAMPLE, U.S. Pat. No. 3,863,145, Issued on Jan. 28, 1975, to Kelly et al. teaches a fault detecting tool that has a metal hook connectable to the end of a switch stick, a coiled connecting cable connected between the metal hook and a current limiting fuse, and a line clamp assembly connected to the fuse. The line clamp assembly has a spring biased arm adapted to clamp the assembly and fuse to a power line.

A SEVENTH EXAMPLE, U.S. Pat. No. 4,326,184, Issued on Apr. 20, 1982, to Murdock teaches an electric cutout that includes a fuseholder in which a fusible element is mounted, a conducting element pivotally mounted to the lower end of the fuseholder and having a pair of trunnions disposed within a pair of spaced jaws on which a pair of guide surfaces are respectively mounted for cooperation with complementary guiding surfaces of arcuate configuration on the conducting element so that rotation of the fuseholder and conducting element about the trunnions may be effected in such manner that the trunnions are securely held against the bight portions of the jaws thereby to prevent rocking action of the fuseholder during closing movement thereof, an ejector latching element pivotally mounted on the conducting element and arranged to eject the fusible element upon rupture thereof and also arranged to engage a part of the fuseholder so as to prevent relative movement between the conducting element and the fuseholder, a U-shaped contact fixed in position adjacent the jaws and arranged to engage opposite surfaces of the conducting element so as to form a low impedance contact therebetween, and yieldable latching means fixed in position and arranged for engagement by latch elements formed on the upper end of the fuseholder and constituting conducting portions of the circuit through the cutout.

AN EIGHTH EXAMPLE, U.S. Pat. No. 4,945,333, Issued on Jul. 31, 1990, to Stroud et al. teaches a fuse assembly for an electrical cutout with capability for rapid arc extinction by a capsule of pressurized insulating gas being located within a fuse tube above the fusible element so that when the fusible element melts and an arc is produced, gas is released from the gas cylinder that quenches and cools the arc and also assists a spring loaded flipper mechanism in expelling a lower conductor from the fuse tube.

A NINTH EXAMPLE, U.S. Pat. No. 5,274,349, Issued on Dec. 28, 1993, to Hassler et al. teaches a fuseholder includes a current limiting fuse mounted within a fuse body and a lower contact and hinge assembly. The fuse body has contact assemblies mounted on each end thereof. The lower contact assembly on the fuse body is mounted on a hinge which is rotatably supported on an interchangeable cutout mounting. The current limiting fuse includes a fuse element spirally wound around a spider which extends the length of the fuse body. The fuse element includes a high current fusible element and a low current fuse element. The fusible element includes a plurality of spaced reduced areas and is supported on the spider by support surfaces which are located between adjacent reduced areas of the fusible element. An auxiliary wire also extends the length of the fuse body about the spider. The hinge includes a hinge member rotatably mounted on the interchangeable cutout mounting, a connective member supporting the contact assemblies and fuse body with current limiting fuse, and a latch for latching the hinge member to the connective member in a contracted position. The latch is connected to a trigger wire attached to the lower end of the auxiliary wire to maintain the hinge and connective members in their contracted position. Upon the melting of the trigger wire due to a current overload, the trigger wire releases the latch thereby allowing the connective member to move to an extended position with respect to the hinge member such that the current limiting fuse drops out of the interchangeable cutout mounting.

A TENTH EXAMPLE, U.S. Pat. No. 5,559,488, Issued on Sep. 24, 1996, to Hassler et al. teaches a fuseholder includes a current limiting fuse mounted within a fuse body and a lower contact and hinge assembly. The fuse body has contact assemblies mounted on each end thereof. The lower contact assembly on the fuse body is mounted on a hinge which is rotatably supported on an interchangeable cutout mounting. The current limiting fuse includes a fuse element spirally wound around a spider which extends the length of the fuse body. The fuse element includes a high current fusible element and a low current fuse element. The fusible element includes a plurality of spaced reduced areas and is supported on the spider by support surfaces which are located between adjacent reduced areas of the fusible element. An auxiliary wire also extends the length of the fuse body about the spider. The hinge includes a hinge member rotatably mounted on the interchangeable cutout mounting, a connective member supporting the contact assemblies and fuse body with current limiting fuse, and a latch for latching the hinge member to the connective member in a contracted position. The latch is connected to a trigger wire attached to the lower end of the auxiliary wire to maintain the hinge and connective members in their contracted position. Upon the melting of the trigger wire due to a current overload, the trigger wire releases the latch thereby allowing the connective member to move to an extended position with respect to the hinge member such that the current limiting fuse drops out of the interchangeable cutout mounting.

AN ELEVENTH EXAMPLE, U.S. Pat. No. 6,392,181, Issued on May 21, 2002, to Cleaveland et al. teaches rapid arc extinguishing devices for air switches with a whip element of strong nonmetallic material, such as of a fiber reinforced plastic or polymer material, with a conductive path, e.g., by metalizing. The whip element can replace the formerly used metal whip in quick break devices for faster separation with less chance of arc restriking and facilitates achieving higher current and voltage ratings.

A TWELFTH EXAMPLE, U.S. Pat. No. 6,392,526, Issued on May 21, 2002, to Roberts et al. teaches a fuse cutout for connection to a power source comprising, a mounting having upper and lower support members extending from opposing ends of the mounting, respectively. A holder member fixedly attached to the lower support of the mounting. A pivot member received in the holder member at a first pivot point, the pivot member being movable between first and second positions. A fuseholder having upper and lower ends, the lower end being pivotally attached to the pivot member at a second pivot point, the fuseholder being movable between closed and open positions corresponding to the first and second positions of the pivot member, respectively. A first biasing member disposed between the pivot member and the lower end of the fuseholder at the second pivot point, biasing the pivot member toward the second position. The pivot member includes a planar cam surface that engages a lower contact of the holder member.

A THIRTEENTH EXAMPLE, U.S. Pat. No. 6,462,639, Issued on Oct. 8, 2002, to Farag et al. teaches a fuse cutout for connection to a power source includes a mounting having upper and lower support members extending from opposing ends of the mounting. The upper support member includes a first contact having opposing first and second end portions, with the first end portion being attached to the upper support member, and a dome portion disposed between the first and second end portions. The dome portion includes opposing first and second dome surfaces and a first ridge extending along the second dome surface. A holder member is fixedly attached to the lower support member of the mounting. A pivot member is received in the holder member at a first pivot point, the pivot member being movable between first and second positions. A fuseholder is movable between closed and open positions and has upper and lower ends. The lower end is pivotally coupled to the pivot member at a second pivot point. The upper end has an engagement surface for engaging the first ridge of the dome portion of the first contact of the mounting forming an electrical connection therewith.

A FOURTEENTH EXAMPLE, U.S. Pat. No. 6,583,708, Issued on Jun. 24, 2003, to Smith et al. teaches a fuse cutout for connection to a power source, includes a mounting having upper and lower support members extending from opposing ends of the mounting. A holder member is fixedly attached to the lower support member of the mounting and a pivot member is received in the holder member at a first pivot point. The pivot member is movable between first and second positions. A lever member, movable between non-release and release positions, has unitary first and second portions. The first portion is pivotally coupled to the pivot member. A fuseholder, movable between closed and open positions, has upper and lower ends, the lower end being pivotally coupled to the pivot member at a second pivot point. The first and second positions of the pivot member and each of the closed and open positions of the fuseholder, correspond to each of the non-release and release positions of the lever member.

A FIFTEENTH EXAMPLE, U.S. Pat. No. 6,593,842, Issued on Jul. 15, 2003, to Haynam et al. teaches an insulator assembly for a polymeric cutout assembly that has a core with first and second ends and an outer surface. First and second end caps are attached at the first and second core ends. The end caps have outer surfaces. A sleeve is disposed on the outer surface of the core. A projection extends laterally outwardly from an outer surface of the sleeve. An insulator is molded around the outer surface of the core, the sleeve and the first and second end caps. A center pin is attached to the projection to secure the cutout assembly to a support.

It is apparent now that numerous innovations for fuse cutouts have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a safety fusible connector that avoids the disadvantages of the prior art.

ANOTHER OBJECT of the present invention is to provide a safety fusible connector that is simple and inexpensive to manufacture.

STILL ANOTHER OBJECT of the present invention is to provide a safety fusible connector that is simple to use.

BRIEFLY STATED, STILL YET ANOTHER OBJECT of the present invention is to provide a safety fusible connector extends between a main feed and a tap of a power line. The connector comprises an insulated tube. A protective sleeve is mounted within an upper portion of the insulated tube. A fuse has an upper contact and a lower elongated fuse line, wherein the fuse is placed within the protective sleeve. The length of the sleeve is longer than the length of the fuse. A first component is attachable to a top end of the insulated tube for electrically connecting the upper contact of the fuse to the main feed. A second component is attachable to a bottom end of the insulated tube for electrically connecting the fuse line of the fuse to the tap. If a fault occurs in the tap the fuse will blow, and cause the second component to disconnect the fuse line, so that the main feed can still have a power supply applied thereto from a primary jumper connected to the tap.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is an elevational view, with parts broken away, showing the safety fusible connector's structure with the protective copper sleeve within the insulated tube;

FIG. 2 shows an elevational view of the safety fusible connector;

FIG. 3 shows a top view of the safety fusible connector when the duck-bill clamp is closed;

FIG. 4 shows a top view of the safety fusible connector when the duck-bill clamp is opened;

FIG. 5 shows a bottom view of the safety fusible connector; and

FIG. 6 shows the safety fusible connector in use with energized main feed and tap line.

### REFERENCE NUMERALS UTILIZED IN THE DRAWING

110 safety fusible connector
112 main feed
114 tap
116 insulated tube of connector 110
118 protective sleeve of connector 110
120 fuse of connector 110
122 upper contact of fuse 120
124 lower elongated fuse line of fuse 120
126 first component of connector 110
128 top end of insulated tube 116
130 second component of connector 110
132 bottom end of insulated tube 116
134 cap of first component 126
136 duck bill clamp of first component 126
138 eyelet bolt of duck bill clamp 136
140 spring loaded mechanism of second component 126
142 flap member of spring loaded mechanism 140
141 a biased spring
144 hot line stirrup of second component 126
146 secondary jumper
148 fiberglass material for insulated tube 116
150 copper metal material for protective sleeve 118
152 conductive metal material for the first component 126 and the second component 130
160 a lever of spring-loaded mechanism 140

### DETAILED DESCRIPTION OF THE PREFERRED EMBODIMENT

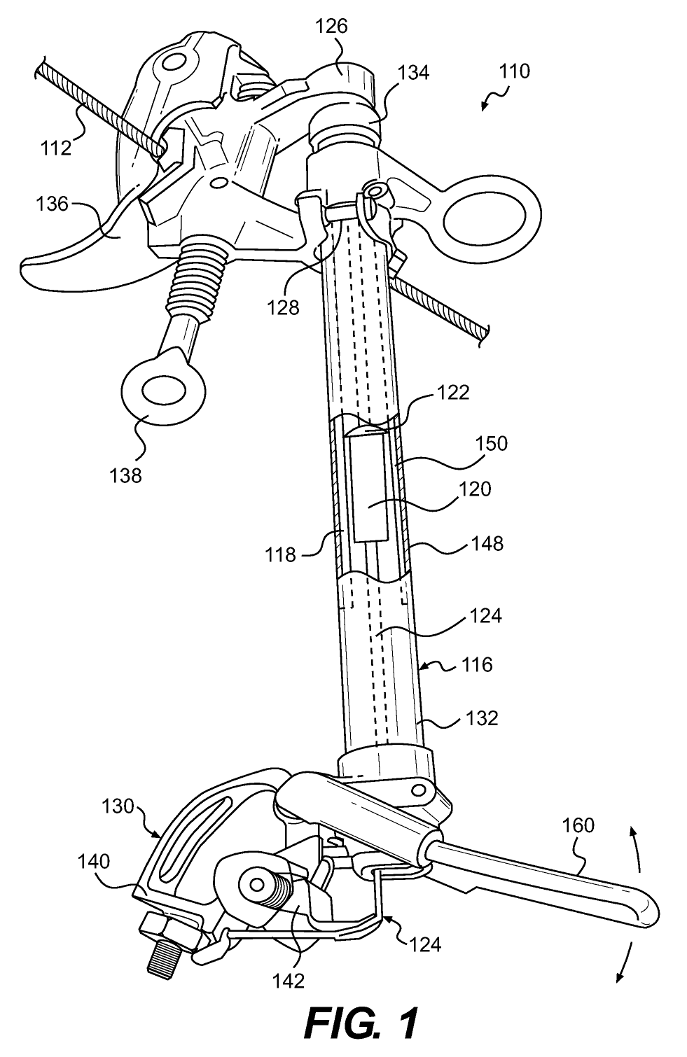

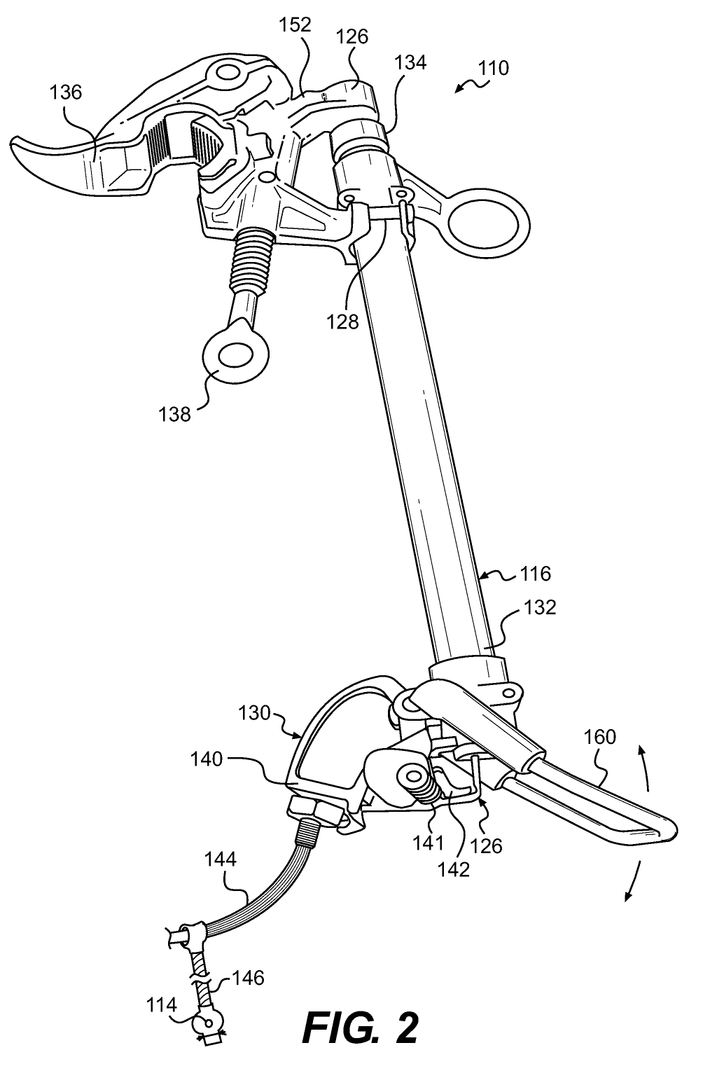

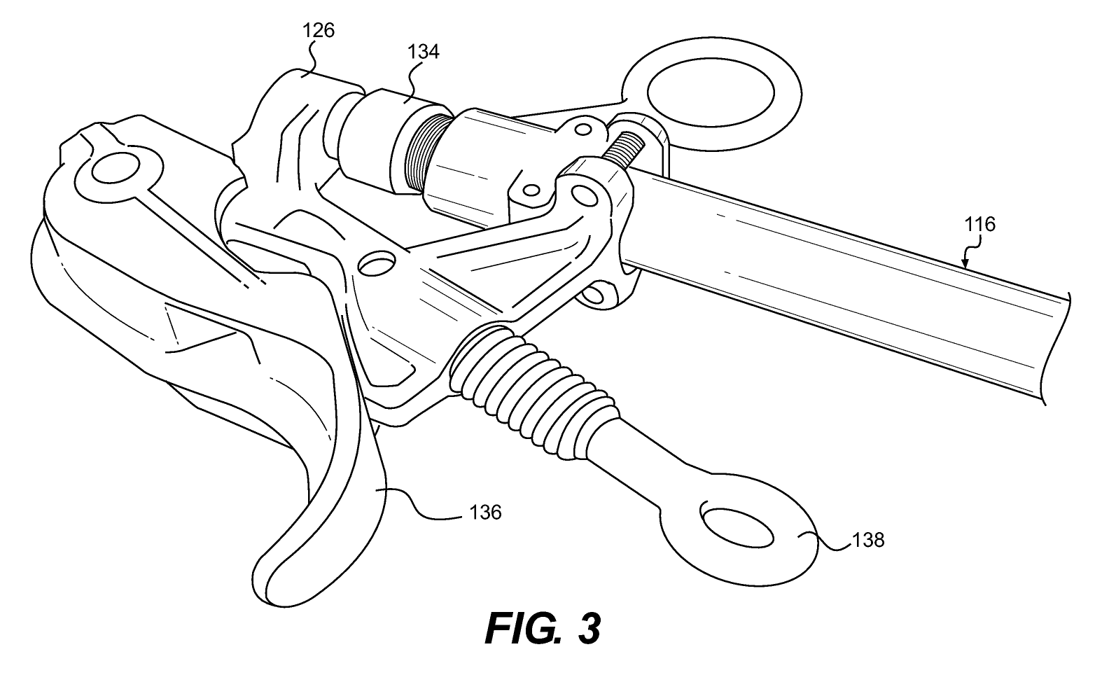

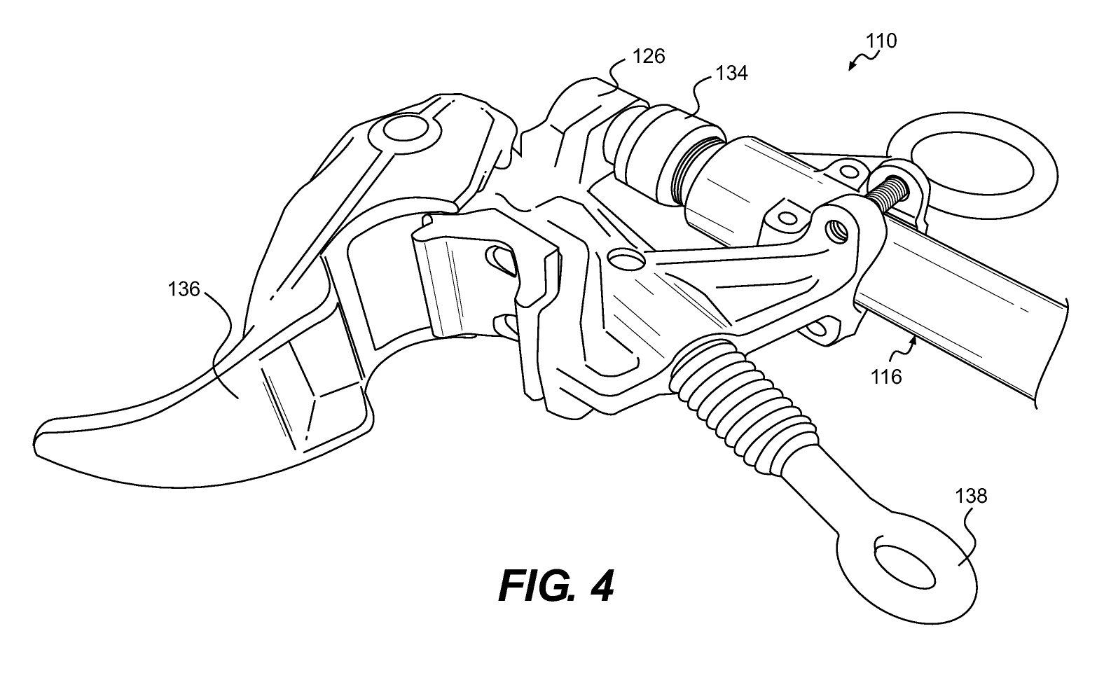

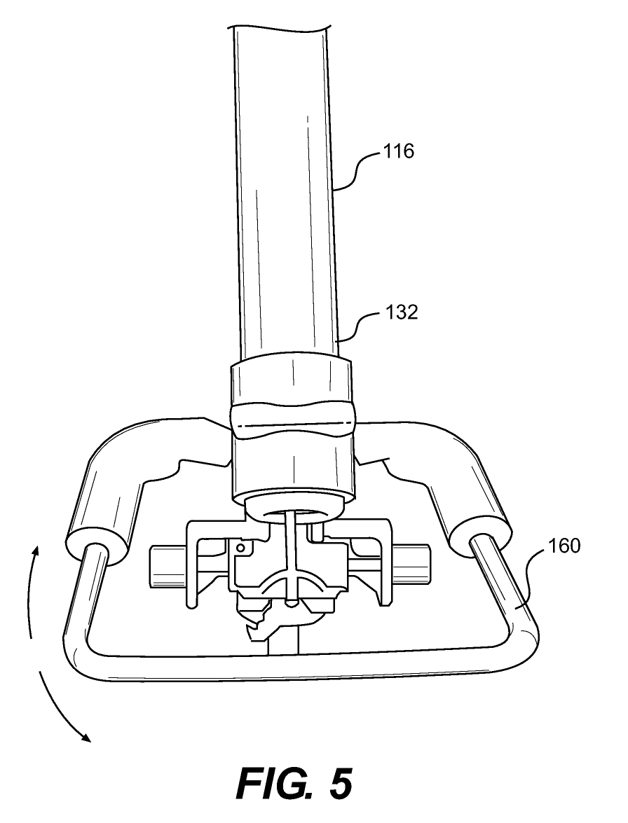

Referring now to the figures, in which like numerals indicate like parts, and particularly to FIGS. 1-6, and as such, will be discussed with reference thereto.

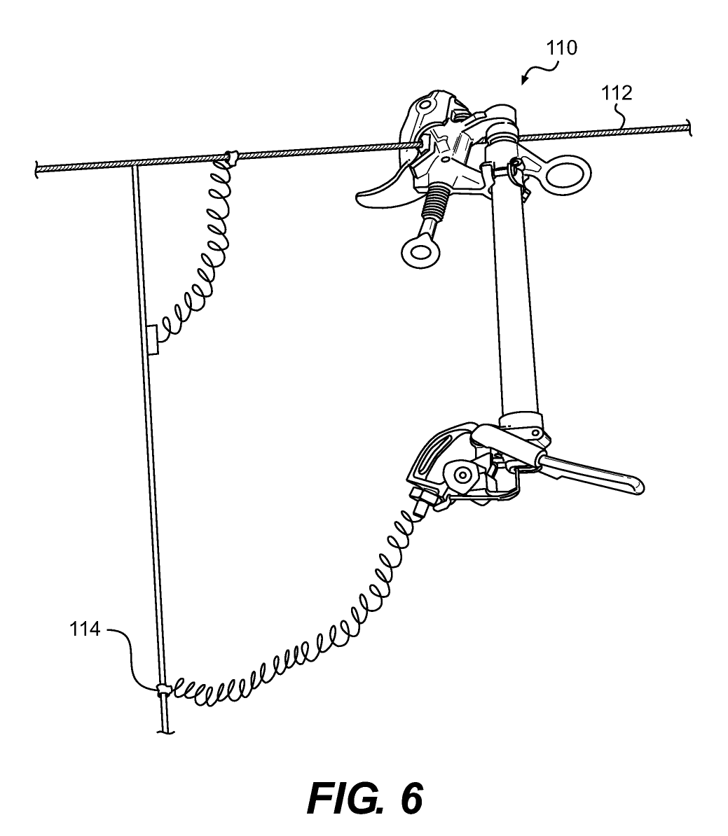

The present invention is a safety fusible connector 110 extending between an energized main feed 112 and a tap 114 of a power line. FIGS. 1-5, show the connector 110 comprises an insulated tube 116. A protective copper sleeve 118 is mounted or snuggly fitted within an upper portion of the insulated tube 116. A fuse 120 has an upper contact 122 and a lower elongated fuse line 124, wherein the fuse 120 is placed within the protective sleeve 118. A first component 126 is attachable to a top end 128 of the insulated tube 116 for electrically connecting the upper contact 122 of the fuse 120 to the main feed 112. A second component 130 is attachable to a bottom end 132 of the insulated tube 116 for electrically connecting the fuse line 124 of the fuse 120 to the tap 114. If a fault occurs in the tap 114 the fuse 120 will blow and cause the second component 130 to disconnect the fuse line 124, so that the main feed 112 can still have a power supply applied thereto from a primary jumper or solid jumper shown in FIG. 6, connected to the tap 114.

The first component 126 comprises a cap 134 which screws into the top end 128 of the insulated tube 116 and electrically connects the upper contact 122 of the fuse 120. A duck bill clamp 136 extends out from the cap 134. The duck bill clamp 136 has an eyelet bolt 138 that can adjustably engage with the main feed 112, which can be of various sizes in diameter.

The second component 130 comprises a spring loaded mechanism 140 rotatably mounted to the bottom end 132 of the insulated tube 116. The spring loaded mechanism 140 has a flap member 142, whereby the free end of the fuse line 124 extends about the flap member 142 and is connected to the biased spring 141. The spring loaded mechanism 140 also has a lever 160 with moving in both directions up and down. A hot line stirrup 144 is connected to the spring loaded mechanism 140, whereby a secondary or temporary jumper 146 can be connected between the hot line stirrup 144 and the tap 114. The temporary jumper 146 uses #2 copper. The temporary jumper 146 can be selected from 1 foot to 20 feet.

When the fuse 120 blows the flap member 142 will rotate with the spring 141 of the spring loaded mechanism 140 and disengage the fuse line 124 away from the fuse 120. So if the tap 114 has faulted, the main feed 112 is still energized. If there is an accident or current fault on the tap 114 the lineman is working on, there is no chance that a flash fire could occur because the fuse 120 is blown up (see FIG. 6). The fault can not be transmitted via the main feeder 112 all the way to the substation.

The insulated tube 116 is fabricated out of a fiberglass material 148, which will allow a visual indication when the fuse 120 blows. The protective sleeve 118 is fabricated out of a copper metal material 150, which will protect the insulated tube 116 from heat when the fuse 120 blows. The insulated tube 116 then can be reused in the next operation. The fiber-glass tube 116 is rated up to 14.4 KVolts. Higher rated tube 116 is used for higher voltages.

The lineman must check the tap's ampere before putting a proper fuse 120 into the connector 110. The current on tap 114 varies from 2 amps to 878 amps. The lineman needs to remove the duck bill clamp 136 before loading the fuse 120 into the tube 116. The ampere value of the fuse 120 is selectable by the lineman. The fuse ampere value is normally less than half size of the ampere value of the circuit breaker on the tap. For example, the ampere value of the circuit breaker is 50 amps, then the ampere value of the fuse should be less than 25 amps. The lineman can select and load manually different fuses 120 with different ampere values for different voltage main feed 112 and the tap 114. The lineman can select the fuse's ampere value as close to the current value of the tap 114. For example, the tap has 10 amps, then the lineman should select the 10-15 amps fuses for his own safety. The solid jumper must be removed after placing the safety fusible connector 110 between the main feed 112 and tap 114. Note: the tap 114 can have high current 136 amps (#2)-179 amps (#2) or up to 878 amps.

The first component 126 is fabricated out of a conductive metal material 152. The second component 130 is also fabricated out of the conductive metal material 152.

In review the safety fusible connector 110 is used in forming a link between the main feed 112 and the tap 114 of the power line. The connector 110 consists of the insulated tube 116, the protective sleeve 118, the first component 126 and the second component 130. The first component 126 attaches to the main feed 112 and screws into the top end 128 of the insulated tube 116. The fuse 120 is located inside the protective sleeve 118. The second component 130 is connected to the tap 114, which creates the fusible link between the main feed 112 and the tap 114. The second component 130 will disconnect the fuse line 124 via the secondary jumper 146 from the tap 114 when there is a fault in the tap 114 and the fuse 120 blows. This ensures that the main feed 112 can still have a power supply applied thereto from the primary jumper. The insulated tube 116 which is made of the fiberglass material 148 provides a visual indication that the fuse 120 has blown. The connector 110 may be approximately eighteen inches high and six inches wide. The exact specifications may vary.

It will be understood that each of the elements described above, or two or more together, may also find a useful application in other types of constructions differing from the types described above.

While the invention has been illustrated and described as embodiments of a safety fusible connector, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A safety fusible connector extending between an energized main feed and a tap of a power line, said connector comprising:
a) an insulated tube;
b) a protective sleeve mounted within an upper portion of said insulated tube;
c) a fuse having an upper contact and a lower elongated fuse line, wherein said fuse is placed within said protective sleeve in which the length of the sleeve is longer than the length of the fuse;
d) a first means attachable to a top end of said insulated tube for electrically clamping said upper contact of said fuse to the main feed; and
e) a second means attachable to a bottom end of said insulated tube for electrically connecting said fuse line of said fuse to the tap, whereby if a fault occurs in the tap said fuse will blow, and cause said second means to disconnect said fuse line, so that the main feed can still have power.

2. The connector as recited in claim 1, wherein said first means comprises:
a) a cap which screws into said top end of said insulated tube and electrically connects said upper contact of said fuse; and
b) a duck bill clamp extends out from said cap, wherein said duck bill clamp having an eyelet bolt that can adjustably engage with the main feed which can be of various sizes in diameter.

3. The connector as recited in claim 1, wherein said second means comprises:
a) a spring loaded mechanism rotatably mounted to said bottom end of said insulated tube, said spring loaded mechanism having a flap member, whereby a free end of said fuse line extends about said flap member and is connected to a biased spring; and
b) a hot line stirrup connected to said spring loaded mechanism, whereby a secondary jumper can be connected between said hot line stirrup and the tap, wherein when said fuse blows said flap member will rotate with said spring loaded mechanism and disengage said fuse line away from said blown fuse.

4. The connector as recited in claim 1, wherein said insulated tube is fabricated out of a fiberglass material, which will allow a visual indication when said fuse blows.

5. The connector as recited in claim 1, wherein said protective sleeve is fabricated out of a copper metal material, which will protect said insulated tube from heat when said fuse blows so the insulated tube can be reused in the next operation.

6. The connector as recited in claim 1, wherein said first means is fabricated out of a conductive metal material.

7. The connector as recited in claim 1, wherein said second means is fabricated out of a conductive metal material.
